(19) United States
(12) Patent Application Publication
(10) Pub. No.: US 2014/0214932 A1
(43) Pub. Date: Jul. 31, 2014

(54) PROFESSIONAL SOCIAL NETWORKING WEB PORTAL AND A METHOD OF REGISTERING THEREIN

(71) Applicant: Michael D. Kane, Naples, FL (US)

(72) Inventor: Michael D. Kane, Naples, FL (US)

(21) Appl. No.: 13/751,221

(22) Filed: Jan. 28, 2013

(51) Int. Cl. H04L 12/58

(52) U.S. Cl. CPC H04L 51/32
USPC 709/204

(57) ABSTRACT

The present invention discloses a professional social networking web portal exclusively for professionals, which confirms registration upon verifying the professional identification information of a member. The social networking web portal includes profiles of registered members including verified professional identification information, a database containing profile information and the professional identification information of all the verified members, a search application that allows a first verified member to discover desired verified members and relevant information based on predetermined search criteria, and a communication platform that allows the first verified member to communicate with the other verified members. Such communications may be exclusively secured within a predefined professional group or shared to other predefined professional groups or all professional groups based on user preference.

### FIELD OF THE INVENTION

The present invention generally relates to a professional social networking website. In particular, the present invention relates to a professional social networking web portal exclusively targeted to medical professionals, legal professionals and PhD professionals.

### BACKGROUND OF THE INVENTION

Social networks have become a large and significant part of human life creating a virtual world where people meet, exchange ideas and create extensions of them and their life without restrictions of physical boundaries and distances.

Presently, the World Wide Web comprises of a number of different social networks that allow all type of users to be a member irrespective of their background and identity. There is a lack of virtual social network comprising of professionals and in particular, that of medical professionals, legal professionals and PhD professionals. There is also no known method wherein the identity and profile information of each such member is verified for authenticity. Currently, the interaction among the users including comments, discussions, blogs, likes, dislikes and other multimedia posting are shared with all the members without restrictions of any kind.

It has been observed by by Kevin et al. in “Emotional Responses During Social Information Seeking on Facebook”, that users of social networking websites are most interested in targeted social searching than random social browsing while navigating such websites. Not only the users spend more time in targeted social searching but also, their emotional needs are satisfied to a great extent when they are involved in targeted social searching rather than random social browsing.

In view of the above discussion, there exists a need to provide a professional social networking web portal which is targeted to medical professionals, legal professionals and PhD professionals, where these predefined group of people with a common shared interest have a platform where the member can share, exchange, develop and enhance knowledge and skill in the field of their common interest as well as communicate social matters. Further, in one dimension of the professional social network, such interaction is secured within the profession and not exposed to the members of other professions, and yet, in another dimension of the professional social network, such interaction may be intertwined only where specifically chosen by the member.

### SUMMARY OF THE INVENTION

The main object of the present invention is to provide a professional social networking web portal which is exclusively targeted to said professionals.

Another object of the present invention is to provide a professional social networking web portal exclusively for medical, legal and PhD professionals, which provides method of verifying profile information and professional identity information of the registered members.

Another object of the present invention is to provide a professional social networking web portal exclusively for said professionals, which provides secure access and communication only to the verified registered members of the professional social networking web portal.

Another object of the present invention is to provide a professional social networking web portal exclusively for said professionals, which provides verified registered members of each particular profession, access to searchable, global knowledge database of works by verified, legitimate, identified authors, which is constantly being expanded and improved upon globally.

Another object of the present invention is to provide a professional social networking web portal exclusively for medical professionals, legal professionals and PhD professionals, which provides detailed professional global directory listing of verified registered members of each particular profession in an organized designated format.

Another object of the present invention is to provide a professional social networking web portal exclusively for said professionals, wherein these professionals are provided the tools for global search of colleagues or other said types of professionals and to quickly and accurately, obtain their desired information.

Another object of the present invention is to provide a professional social networking web portal exclusively for said professionals, which provides a platform where such professionals of similar or diverse professions from around the globe may meet, mingle, share and experience for both professional and social purposes, including but not limited to, world health, world economics, investments, ethics, education, pathology, pharmaceuticals, entertainment, employment, religion, politics, medical and other purposes.

In order to achieve the above mentioned objects, the present invention discloses a professional social networking web portal exclusively targeted to one or more professionals, implemented in a computer network including a network server and at least one database accessible by the network server. The professional social networking web portal includes profiles of one or more registered members including at least verified professional identification information, the member profiles being classified by one or more such professions, a database containing profile information and the professional identification information of all the registered members, a search application that allows a first verified member to discover one or more desired verified members and information related thereto based on predetermined search criteria, and a communication platform that allows the first verified member to communicate with the one or more other verified members. Such communications with the one or more verified members within a predefined professional group and the contents thereof are exclusively secured within such professional group and hidden from members of other professional groups of the professional social networking web portal.

In one embodiment, the communications with the one or more verified members are shared with predefined professional groups or all professional groups based on user preference.

In one embodiment, the predefined search criteria for the search application includes profession, gender, age, preference, religion, language, ethnicity and key words.

In one embodiment, the professional social networking web portal includes a professional directory listing including the profiles of all verified members, wherein the professional directory listing is searchable by at least one of profession, location, specialty, special interest and key terminology.

In one embodiment, the professional directory listing includes a second version with limited access to the profile information and the professional identification information of all the verified members. The second version of the professional directory listing may be accessible to non-registered members.

In one embodiment, the professional social networking web portal includes classified postings created by the one or more professionals, wherein the classified postings are searchable at least by profession and other sub categories, the postings are either shared within members of same profession or predefined professions or all professions, based on the user preference.

In one embodiment, the professional social networking web portal includes personal postings created by the one or more professionals, wherein the personal postings are searchable at least by profession and other sub categories, the personal postings are either shared within members of same profession or predefined professions or all professions, based on the user preference.

In one embodiment, the professional social networking web portal includes forums created by the one or more professionals, wherein the forums include professional forums and social forums, which are searchable at least by profession and other fields, the forums either shared within members of same profession or predefined professions or all professions, based on the user preference.

In one embodiment, the professional social networking web portal includes Continuing Education (CE) courses accessible to professionals of the same profession, wherein the CEs are classified by at least one of free CEs, discounted CEs, coupon CEs, special offer CEs, retail CEs, top rated CEs. Further, the CE courses are provided by one or more qualified entities that have previously joined and gone through the registration and verification process as set forth by the professional social networking web portal.

In one embodiment, the professional social networking web portal includes list of products for sale exclusively to the one or more professionals, wherein such products are classified by at least one of free products, discounted products, coupon products, special offer products, retail products, top rated products. Further, the list of products are provided by one or more qualified entities that have previously joined and gone through the registration and verification process as set forth by the professional social networking web portal.

In one embodiment, the professional social networking web portal includes list of professional services exclusively for the one or more professions, wherein such professional services are provided by one or more qualified entities that have previously joined and gone through the registration and verification process as set forth by the professional social networking web portal.

In one embodiment, the communications between the one or more professionals comprise text blogging, sound blogging and video blogging.

In one embodiment, the communications between the one or more professionals include establishing digitized convention and virtual conferences with the one or more professionals.

In one embodiment, the communications between the one or more professionals, relate to at least one of professional, entertainment, employment, religious, political or medical matters.

In one embodiment, the communications between the one or more professionals are saved in a database for back up, which allows access to such communications in future.

In one embodiment, the professional social networking web portal as claimed in claim 1, comprising a single source for accessing a plurality of multimedia communications including blogs, forums, classifieds, personals, CEs, products, and professional directory listing without accessing multiple websites.

In one embodiment, the professional social networking web portal's unique configuration and environment, results in a unique pleasant emotional and physical response to the communications between the one or more professionals, the nature of the response to one or more emotional stimuli posted therein, the duration of said response to such one or more stimuli, and the corresponding physical actions as a result of said one or more stimuli.

In another embodiment, the professional social networking web portal includes posting directed advertisement by one or more qualified entities based on the unique configuration and environment and emotional response of a registered member.

In one embodiment, the professional social networking web portal includes automatically obtaining emotional response of the registered members from the communications between the one or more professionals. Further, the emotional response of the registered members may be obtained from the nature of response to one or more emotional stimuli posted therein and the duration of said response.

In another aspect of the present invention, a method of registering to a professional social networking web portal exclusively targeted to one or more professionals is disclosed. The method includes submitting profile information and professional identification information by a registering member, verifying the professional identification information of the registering member by the professional social networking web portal, and confirming registration of the registering member based on the authenticity of the professional identification information.

In one embodiment, the professional identification information includes at least one selected from legal name, professional license number, country of issuance of the license, area of practice, National Practitioner Identification Number.

In one embodiment, verifying the professional identification information includes verifying the professional identification information automatically by a third party authentication agency accessed by the professional social networking web portal.

In one embodiment, the verifying the professional identification information includes verifying the professional identification information manually by an administrator of the professional social networking web portal.

In one embodiment, the method of registering to a professional social networking web portal includes registering as an identified member which allows displaying the profile information and professional identification information of the verified member on the professional social networking web portal, wherein the other verified members are authorized to view the profile information and the professional identification information of said verified member.

In another embodiment, the method of registering to a professional social networking web portal includes registering as an anonymous member wherein the profile information and the professional identification information of said verified member are kept hidden from the other verified members.

In another embodiment, the method of accessing the professional social networking web portal includes switching one or more times from identified profile to anonymous profile and anonymous profile to identified profile by the verified member who has gone through the login process once, as set forth by the professional social networking web portal.

It is to be understood that both the foregoing general description and the following detailed description of the present embodiments of the invention are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and together with the description serve to explain the principles and operation of the invention.

### BRIEF DESCRIPTION OF THE DRAWINGS

The above-mentioned and other features and advantages of the embodiments of the invention, and the manner of attaining them, will become more apparent and will be better understood by reference to the accompanying drawings, wherein:

FIG. 1 schematically illustrates a professional social networking web portal exclusively targeted to one or more professionals implemented in a computer network according to one embodiment of the present invention;

FIG. 2 is a flowchart showing a method of registering into a professional social networking web portal exclusively targeted to one or more professionals according to one embodiment of the present invention;

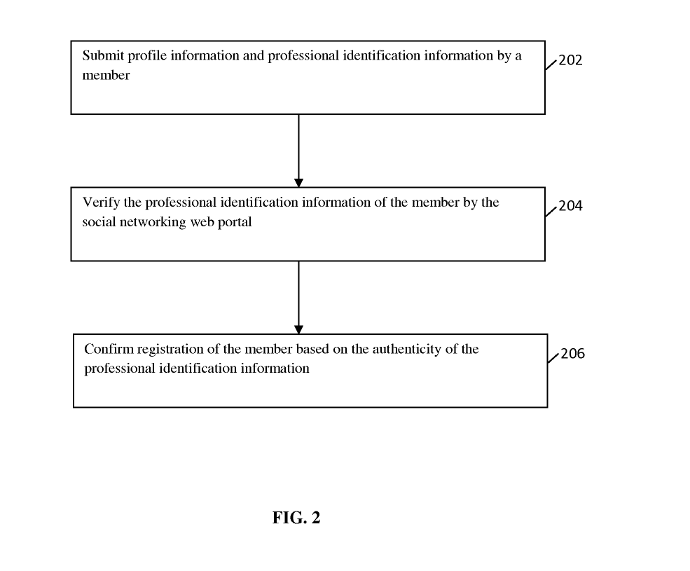

FIG. 3 illustrates a registration page of a professional social networking web portal exclusively targeted to one or more professionals according to one embodiment of the present invention;

FIG. 4 illustrates a home page of a professional social networking web portal exclusively targeted to one or more professionals according to one embodiment of the present invention;

FIG. 5 illustrates a home page of anonymous side of a professional social networking web portal exclusively targeted to one or more professionals according to one embodiment of the present invention;

FIGS. 6 and 7 illustrate personals posting feature of a professional social networking web portal exclusively targeted to one or more professionals according to one embodiment of the present invention; and

FIG. 8-12 illustrate different aspects of forums feature of a professional social networking web portal exclusively targeted to one or more professionals according to one embodiment of the present invention.

### DETAIL DESCRIPTION OF THE INVENTION

Reference will now be made in detail to the exemplary embodiment(s) of the invention, examples of which are illustrated in the accompanying drawings. Whenever possible, the same reference numerals will be used throughout the drawings to refer to the same or like parts.

In this document, the terms “comprises,” “comprising,” or any other variation thereof, are intended to cover a non-exclusive inclusion, such that a process, method, article, device or apparatus that comprises a list of elements does not include only those elements but may include other elements not expressly listed or inherent to such process, method, article, device, or apparatus. An element proceeded by “comprises . . . a” does not, without more constraints, preclude the existence of additional identical elements in the process, method, article, device or apparatus that comprises the element.

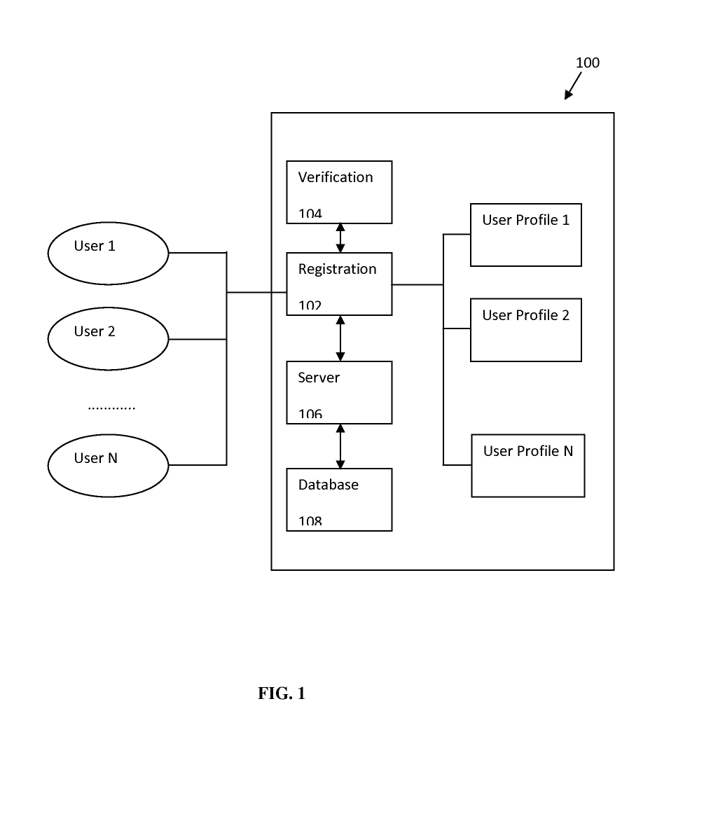

Disclosed herein is a professional social networking web portal and a method of registering on such professional social networking web portal. In an exemplary embodiment, the professional social networking web portal may be exclusively targeted to medical, legal and PhD professionals. FIG. 1 schematically illustrates a computer network system including such a professional social networking web portal 100 according to one embodiment of the present invention. For example, the professional social networking web portal 100 may be a computer network based professional social network that is a service and/or a platform that facilitates building online professional social relations amongst users of the professional social network. A network platform such as CentOs 6 Linux may be used to implement such professional social networking web portal 100. The professional social networking web portal 100 may include a registration unit 102, a verification unit 104, a network server 106, a database 108 and plurality of user profiles.

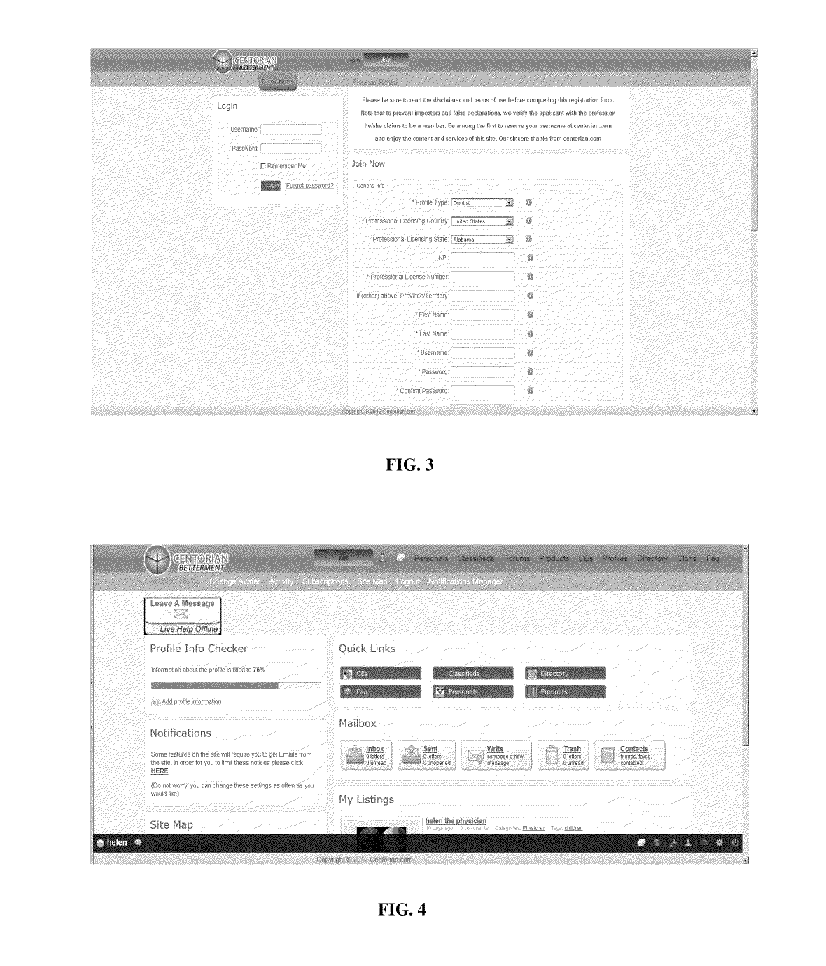

As discussed above, the professional social networking web portal 100 is exclusively targeted to one or more professionals such as medical, legal and PhD professionals. Therefore, the professional social networking web portal 100 requires a network user to fill out the joining form and submit his form which includes information about his profile and professional identification (shown at 202). In particular, it is mandatory for the network user to submit his registration information such as legal name, professional license number if he has been issued such number (shown at FIG. 3). For example, in the area of medical doctors, the information may contain their National Provider Identification Number (NPI). The profile information may include first name, last name, username, password and other personal details such as sex, address, contact details including email address, mobile number and so forth. These profile information and professional identification information are then verified by the professional networking web portal 100 (shown at 204). The verification may be done automatically using a computer program which accesses third party web sites to verify the authenticity of such profile information and professional identification information. Further in the event such third party verification sites are unavailable or inaccessible, the verification may be done manually by an administrator of the professional social networking web portal 100. Upon verifying the authenticity of the profile information and the professional identification information, the users are registered as verified members and are permitted to access the site (shown at 206).

The verified members of the professional social networking web portal 100 may access advanced features of the professional social networking web portal 100. For example, a registered member may send emails to other verified members with attachment of size of 250 MB and above. In one embodiment, such secure emails may be transmitted to external unregistered users with minimum size of an attached file of 250 MB. Further, the secured email services granted specifically to verified members of the professional social networking web portal 100 does not allow generalized advertisements, and it may allow only in specific inconspicuous area, therefore the web portal looks neat and clean and serves the purpose of professional requirements only. The verified members also may also avail themselves of digitized convention/congress with other verified members. In addition to text blogs, the professional social networking web portal 100 may allow the members to post audio and video blogs. The verified members may upload an already existing audio/video blogs stored on their computer system or they may create fresh audio/video blogs with a recording option of the professional social networking web portal. All communications between the verified members of a profession are highly secured and private to within the verified members of the same profession, as well as hidden from verified members of other professionals and all unregistered members.

In one embodiment, the professional networking web portal may allow verified members, various modes of access. One such mode of access is where the verified is permitted to access the professional social networking web portal as identified in one sphere and anonymous in another sphere of the professional social networking web portal. There is a major distinction between these two areas which is discussed below in detail.

In one embodiment, another such mode of access to the professional networking web portal is where the verified member is permitted to access the professional social networking web portal only as anonymous and only in the anonymous sphere of the professional social networking web portal.

In yet another embodiment, the professional social networking web portal may allow verified members another mode of access wherein the verified member is permitted to access the professional social networking web portal only as identified verified member and only in the member identified sphere of the professional social networking web portal.

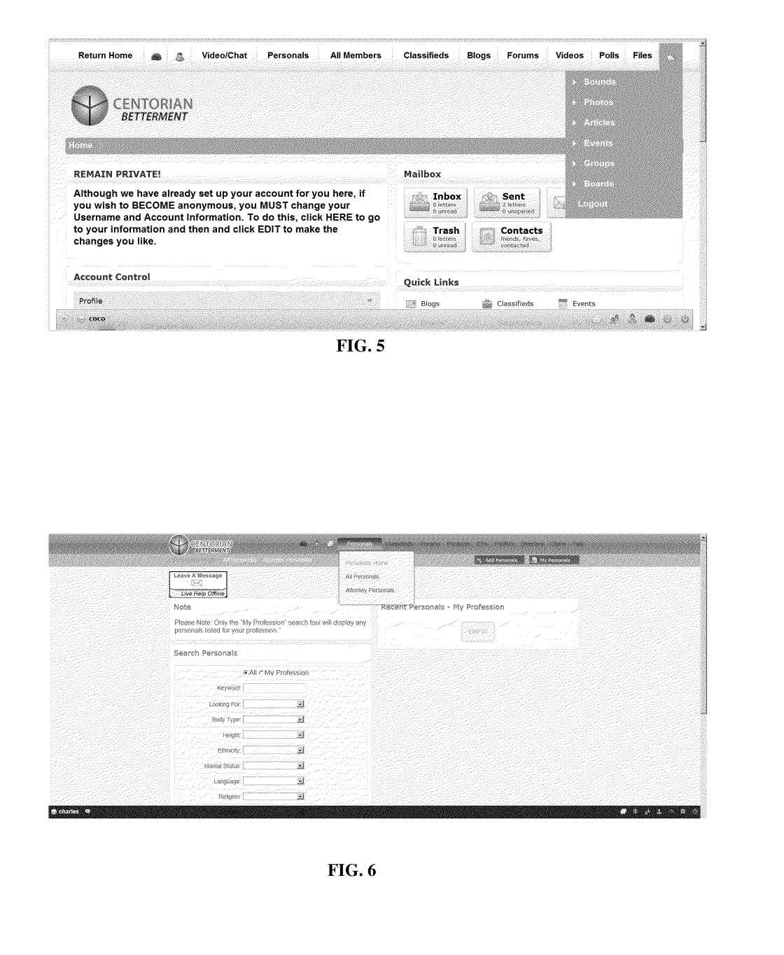

In the member identified side of the professional social networking web portal, the profile and profession information of all verified members are displayed on the member profile. The profile information and the profession information that is submitted by the member and verified by the professional social web portal 100, is the information that is available for viewing to all other verified members. By registering with the professional social web portal, each member agrees to all terms, conditions and disclaimer of the professional social networking web portal 100. Therefore they are obligated to update their profile information in the event they legally change their name or other essential registration information. Hence, the true and current identity of each verified member is visible and known to all other verified members. FIG. 4 shows home page of such a mode of access according to one embodiment of the present invention.

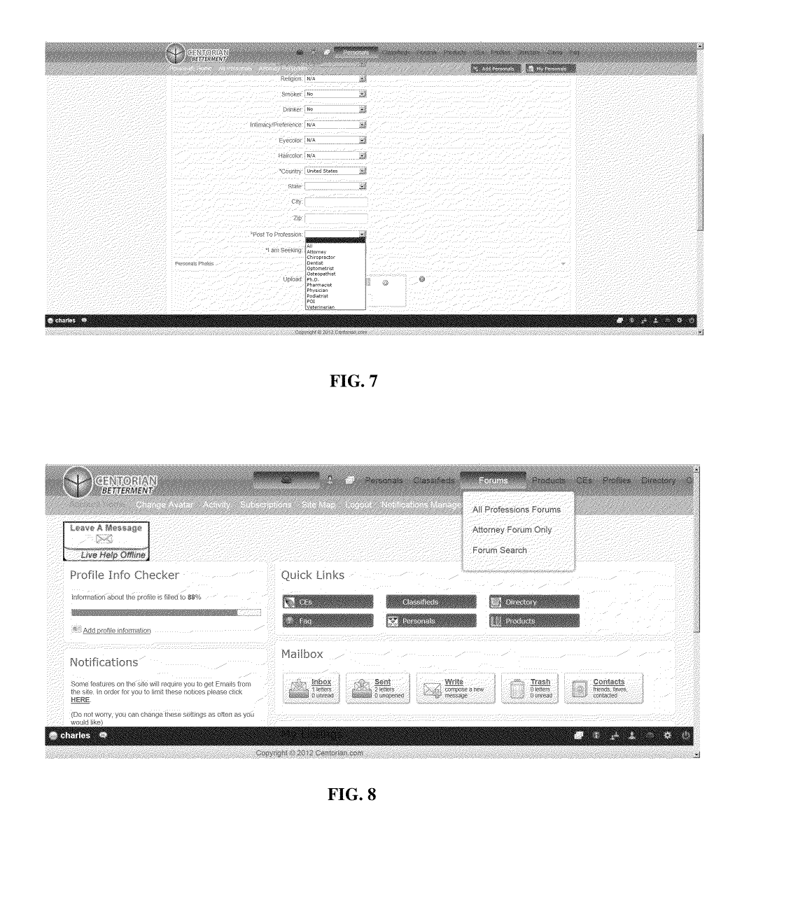

However, the verified members who choose to access the anonymous area of the website may change their profile information such as identity and username to create their profile as anonymous without giving real name and identity information. Further, all verified members may change their identity as often as they choose. However all the members who are registered in the anonymous sphere are professionals and they have been verified the same way as the members in the identified side have been verified. These anonymous verified members may access the above mentioned features such as member directory, classifieds, forums, blogs, video blogs, video postings, photo postings, sounds postings, events, groups, articles, subscriptions, files and so forth. The anonymous verified members may also participate in polls conducted on various issues. These verified members also may avail themselves of instant message and voice and video chat features. FIG. 5 shows home page of such a mode of access according to one embodiment of the present invention.

In one embodiment, the professional social networking web portal 100 further allows another type of persons to join as a member, where verification is done on a person by person basis. These individuals may be referred as POI (Persons of Importance/Persons of Influence). These individuals are, for instance, individuals such as persons in the forefront of innovation who may not be doctorates or registered practitioner of a profession, but whose membership in the professional social networking web portal 100 would greatly contribute to the advancement of the member professionals and the society at large.

In one advantage, the present invention provides these professionals, a platform wherein they can freely communicate with other verified members of same profession in an environment that is exclusive to them and not to the verified members of the other professions. This may provide many incentives for such professionals. For example, the professional social networking web portal 100 may provide a secure platform where physicians or surgeons can communicate and share information and multimedia material on, for example, open heart surgery. Hence these doctors can communicate freely without the fear of a public person or non-physician member saying that they were traumatized by viewing the multimedia content or relied upon it as medical advice which was not the intent of the communication.

In another advantage of the present invention, the professional social networking web portal 100 provides a platform for one type of professionals to communicate directly with verified members of other professions regarding issues that relate to more than one areas of interest. Such inter professional communication may enhance the ability of these professionals to perform their own professions in a better manner. Therefore, this feature of the present invention provides a platform, in form of web portal, where such professionals can meet and mingle socially as well as professionally, and intelligently, effectively and efficiently discuss problems like world health, world economics, investments, ethics, education, pathology, pharmaceuticals, and more, on both a local as well as a global scale.

In another advantage, the professional social networking web portal 100 provides a global virtual convention for the registered members. This includes the ability of the verified members to join and attend global digitised virtual conventions, conferences, seminars, meetings and other such gatherings with verified members of their own profession or with verified members of other professions or all professions.

In yet another advantage, the professional social networking web portal 100 has filled the gap in the global arena of professional social networking sites by creating a unique platform wherein medical, legal and PhD professionals from around the globe, may have exclusive communication with verified members of their own profession and/or with verified members of other professions. Furthermore, this invention has created a platform for said professionals, a direct access to a searchable source of knowledge that is constantly being expanded and improved by the verified members of the particular profession. Also, it provides a direct access to the professional by whom that information was provided.

In another advantage, the professional social networking web portal 100 has created a global source wherein members from around the globe can implement their detailed professional directory listing in a customized format. This professional directory may be designed as easily searchable by categories relevant to such professions. The professionals may search for professionals of their own profession or for professionals of other professions, in a quick and user-friendly manner to obtain the information they want. In an embodiment, the directory listing may have two formats. One format of the directory listing may contain full profile and professional details which may be accessible only to the verified members of the professional social networking web portal 100. Another format of the directory listing may contain only professional details with professional profiles which may be accessible and searchable by non-members of the professional social networking web portal.

Further, the topic of interaction or communication between the verified members may not always be limited to a subject of professional interest. The professional social networking web portal 100 also provides a platform and source where these professionals of similar or diverse professions from around the globe may meet, mingle, share and experience other subjects that includes and not limited to professional, entertainment, employment, religious, political, health and other matters.

As discussed before, the professional social networking web portal 100 creates a platform for numerous types of needs that medical, legal and PhD professionals may have on a daily basis in practicing their professions. It creates one comprehensive source and thereby minimizes their time and effort to research and obtain the information from different sources in order to meet their interest or requirement. For example, it may help in completing professional duties of education or due diligence, or allow them to communicate with colleagues, and enhance and expand collegial relationships, or reject or confirm, their findings, or just interact regarding special interests, all in one source.

In another embodiment, the professional social networking web portal 100 provides a platform wherein the verified members may avail themselves of Continuing Education (hereinafter CE) courses. This may satisfy their professional obligations (whether mandatory or optional) to complete a number of courses required as part of their professional developments. The CE courses may be selected as designated in particular state, province or territory. The CEs may be provided by qualified and verified publishers and group of professionals that have previously joined the professional social networking web portal 100 through the same registration process as required by the site. In an exemplary embodiment, the CEs may be classified under sub-categories such as free, discounted, coupon, special offer, retail, top rated and so forth. The Continuing Education (CE) course material are accessible to professionals of that specific profession for whom the material was posted, where such posting is private and accessible only by the verified member's own profession and no other professions.

In yet another embodiment, the professional social networking web portal 100 provides a platform wherein its verified members may have direct access to the said products that are either established or novel in their area of practice. These products might be provided by qualified entities that have previously joined the professional social networking web portal 100 and have gone through the registration process as set forth by the site. In an exemplary embodiment, the products may be classified under sub-categories such as free, discounted, coupon, special offer, retail, top rated and so forth. Further, the verified members may access third party web sites to view advertisements or obtain products of these qualified entities. These postings by qualified entities are secured and exclusively restricted within the professions as selected by the creator of the post or displayed to all professions, but are not open to public.

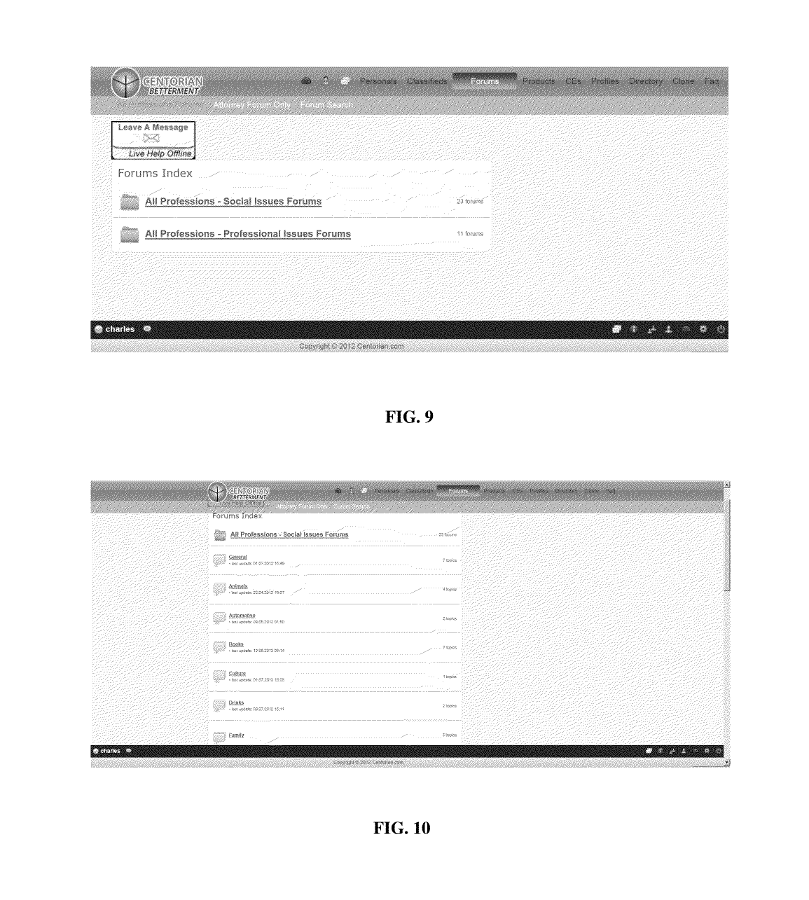

Further the professional social networking web portal 100 creates a platform wherein its verified members may directly post their classified advertisements that may be viewable to all the professionals of their own profession only. For example, an attorney may post a classified advertisement regarding sale of a legal practice which may be visible only to other attorneys and not a physician or a veterinarian and not to the public at large. Optionally, the member may post classifieds which are targeted at all professional members and reset the privacy setting so that the post may be visible to selected or all professions. For example, an attorney may for instance post his vehicle for sale in a way that allows verified members of all professions, including the attorneys, to see it and express interest on the post. FIG. 6 shows such feature of classified posting on the professional social networking web portal 100 according to one embodiment of the present invention.

As described above, the members may have the option to select the type of professionals they would like viewing and accessing their personals posting. An attorney, for example, may want to find a partner that is a veterinarian, he would therefore post his personals to be viewed and accessed by verified members of the veterinary profession only. Further, the members may have the flexibility to post his personals advertisements for access by all professionals, including his own profession, as explained above. In this way the professional social networking web portal 100 provides a great deal of flexibility as well as security for posting the personals advertisements. FIG. 7 shows such feature of personal posting on the professional social networking web portal 100 according to one embodiment of the present invention.

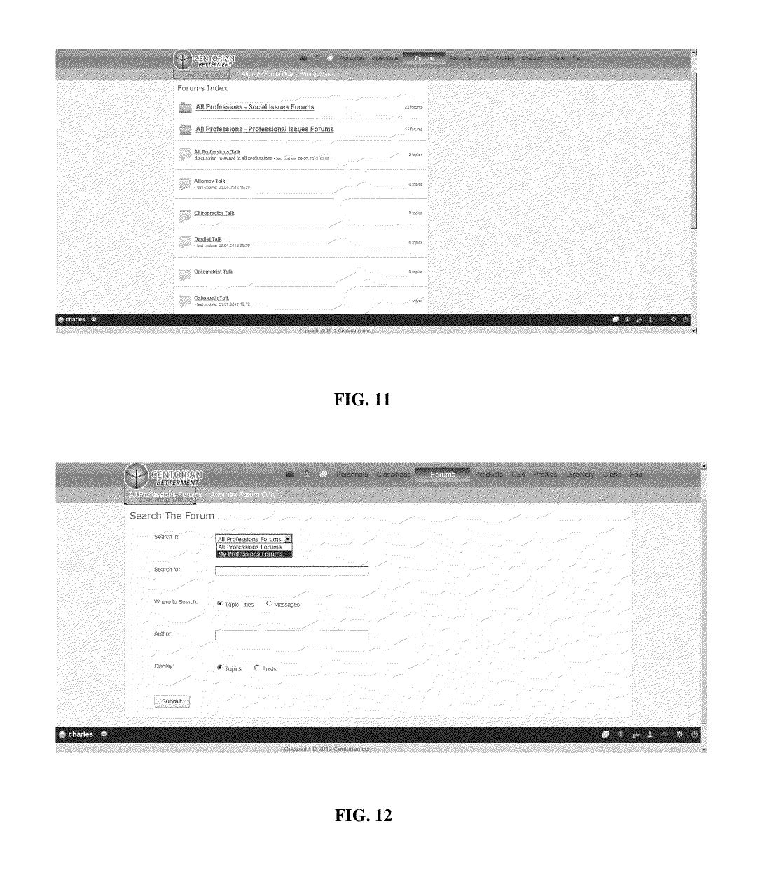

In another embodiment, the professional social networking web portal 100 may offer more social, entertaining, relaxing, non-professional aspects to the professional member's life. The verified members may have access to social forums where they may discuss matter of social interest or they may choose to access professional forums where they may discuss matters of professional interest. The members may pursue these interests by communicating and mingling with verified members of their own profession or members or professionals of other professions. Hence, the present invention provides forum where they can target their discussion or enter other on-going discussions that are distinct to their interest. In this way, it minimizes the members' effort to go online and search for a forum or blog or document that addresses that particular topic. In an exemplary embodiment, the forums may be distinguished into two sections, such as the professional forums and social forums. The professional forums further may be available in a list of categories on which the verified members may select to post their comments. The professional forums also may be categorised by the professions. The professionals may have the ability to create their own categories wherein they may post their communications on any one professional forums or a forum inclusive of all professions. FIG. 8-12 shows such feature of professional and social forums on the professional social networking web portal 100 according to one embodiment of the present invention.

In another embodiment, the registered members may have a designated profile area where they may post their professional achievements and allow it to be viewable to select group members or all group members. In this profile section, a member may have the ability to search other members with similar professional interest and communicate with such members. This ensures the members to know who exactly they are communicating with, his profession and the professional background of such member.

In another embodiment, the registered members may have a designated profile area where they may post their social and personal achievements and allow it to be viewable to select professions or all professions or, to select verified members. In this profile section, a member may have the ability to search other verified members with similar interests and communicate with such verified members.

In another embodiment, the verified member may access third party web sites for some special professional services. These communications and provided services between the third party websites and the verified members are highly secured and strictly restricted to that profession or that verified. Only the desired professions or professional member may access such communication and are kept hidden from the public. The professional services may include but are not limited to, data mining portal, data donation portal, accounting services, insurance advice, financial planning, databank services, invoicing services, processing services, auction services, all of which are specifically designed to meet the particular needs of medical, legal and PhD professionals. Online buying and selling may be available for buying or selling of products. Such advertisement postings may be restricted within each profession and hidden from public. Further all online and offline communications between the verified members may be saved and kept as backup for future communication use. In one embodiment, cloud based storage and usage may be used for such purpose.

In another embodiment, the unique environment of the professional social network created herein, stimulates emotional response unique to this social network as designed for such groups of legal professionals, medical professionals and Ph.D. professionals as a whole. The emotional and physical response of the verified members to the various stimuli, including but not limited to postings, advertisements, products or services, within the professional social networking web portal is unique to this invention. The unique emotional and physical response of the verified members stems from the environment created specifically for said professionals. The professional social networking web portal is exclusive to verified members of said professions and thereby creating a secure, exclusive and ideal platform for such professionals to interact among themselves or verified members of other exclusive professions. For example, the emotional stimuli may include advertisements and promotions posted on the professional social networking web portal targeted to one or more professions, in particular to the legal professionals, medical professionals and Ph.D. professionals. Further, the qualified entities may post directed advertisement based on the emotional response of verified members of that profession.

The emotional responses of the registered members are automatically obtained from the communications between the one or more professionals.

Although the present embodiments have been described with reference to specific example embodiments, it will be evident that modifications and changes may be made to these embodiments without departing from the broader spirit and scope of the embodiments. For example, the devices and modules described herein may be enabled and operated using hardware circuitry, firmware, software or any combination of hardware, firmware, and software (e.g., embodied in a machine readable medium). For example, the electrical structure and methods may be embodied using transistors, logic gates, and electrical circuits (e.g., application specific integrated (ASIC) circuitry and/or in Digital Signal Processor (DSP) circuitry).

In addition, it will be appreciated that the operations, processes, and methods disclosed herein may be embodied in a machine-readable medium and/or a machine accessible medium compatible with a data processing system (e.g., a computer devices), and may be performed in any order (e.g., including using means for achieving the operations). The operations discussed above may be tangibly embodied on a medium readable through the retail portal to perform functions through operations on input and generation of output. These input and output operations may be performed by a processor. The medium readable through the retail portal may be, for example, a memory, a transportable medium such as a CD, a DVD, a Blu-ray™ disc, a floppy disk, or a diskette. A computer program embodying the aspects of the exemplary embodiments may be loaded onto the retail portal. The computer program is not limited to specific embodiments discussed above, and may, for example, be implemented in an operating system, an application program, a foreground or background process, a driver, a network stack or any combination thereof. The computer program may be executed on a single computer processor or multiple computer processors. Accordingly, the specification and drawings are to be regarded in an illustrative rather than a restrictive sense. Further, the computer program and the professional social networking web portal, in particular, may be accessed by a user hand held device which includes and not limited to a mobile phone, a smart phone, PDA, tablet and so forth.

Any embodiment described herein is not necessarily to be construed as preferred or advantageous over other embodiments. All of the embodiments described in this detailed description are illustrative, and provided to enable persons skilled in the art to make or use the disclosure and not to limit the scope of the disclosure, which is defined by the claims.

We claim:

1. A professional social networking web portal exclusively targeted to one or more professionals, implemented in a computer network including a network server and at least one database accessible by the network server, the professional social networking web portal comprising:
profiles of one or more registered members including at least verified professional identification information, the member profiles being classified by one or more such professions;
a database containing profile information and the professional identification information of all the registered members;
a search application that allows a first verified member to discover one or more desired verified members and information related thereto based on predetermined search criteria; and
a communication platform that allows the first verified member to communicate with the one or more other verified members,
wherein such communications with the one or more verified members within a predefined professional group and the contents thereof are exclusively secured within such professional group and hidden from members of other professional groups of the professional social networking web portal.

2. The professional networking web portal as claimed in claim 1, wherein the communication with the one or more verified members are shared with predefined professional groups or all professional groups based on user preference.

3. The professional networking web portal as claimed in claim 1, wherein the predefined search criteria for the search application comprises at least one selected from profession, gender, age, preference, religion, language, ethnicity and key words.

4. The professional social networking web portal as claimed in claim 1, comprises a professional directory listing including the profiles of all verified members, wherein the professional directory listing is searchable by at least one of profession, location, specialty, special interest and key terminology and accessible only by verified members of the professional social networking web portal.

5. The professional social networking web portal as claimed in claim 4, wherein the professional directory listing comprises a second version thereof with limited access to the profile information and the professional identification information of all the registered members, said second version of the professional directory listing being accessible to non-registered members.

6. The professional social networking web portal as claimed in claim 1, comprises classified postings created by the one or more professionals, wherein the classified postings are searchable at least by profession and other sub categories, the classified postings are secured within one profession or shared with other professions based on the user preference.

7. The professional social networking web portal as claimed in claim 1, comprises personal postings created by the one or more professionals, wherein the personal postings are searchable at least by profession and other sub categories, the personal postings are secured within one profession or shared with other professions based on the user preference.

8. The professional social networking web portal as claimed in claim 1, comprises forums created by the one or more professionals, wherein the forums include professional forums and social forums, which are searchable at least by profession and other fields, the forums are shared with members of same profession or predefined professions or all professions based on the user preference.

9. The professional social networking web portal as claimed in claim 1, comprises Continuing Education (CE) courses accessible to professionals of the same profession, wherein the CEs are classified by at least one of free CEs, discounted CEs, coupon CEs, special offer CEs, retail CEs, top rated CEs.

10. The professional social networking web portal as claimed in claim 9, wherein the CE courses are provided by one or more qualified entities that have previously joined and gone through the registration process as set forth by the professional social networking web portal.

11. The professional social networking web portal as claimed in claim 1, comprises list of products for sale exclusively to the one or more professionals, wherein such products are classified by at least one of free products, discounted products, coupon products, special offer products, retail products, top rated products.

12. The professional social networking web portal as claimed in claim 11, wherein the list of products are provided by one or more qualified entities that have previously joined and gone through the registration process as set forth by the professional networking web portal.

13. The professional social networking web portal as claimed in claim 1, comprises list of professional services exclusively for the one or more professions, wherein such professional services are provided by one or more qualified entities that have previously joined and gone through the registration process as set forth by the professional networking web portal.

14. The professional social networking web portal as claimed in claim 1, wherein the communications between the one or more professionals comprise text blogging, sound blogging and video blogging.

15. The professional social networking web portal as claimed in claim 1, wherein the communications between the one or more professionals comprise establishing digitized convention and virtual conferences with the one or more professionals.

16. The professional social networking web portal as claimed in claim 1, wherein the communications between the one or more professionals relate to at least one of professional, entertainment, employment, religious, political, medical matters.

17. The professional social networking web portal as claimed in claim 1, comprising a single source for accessing a plurality of multimedia communications including at least instant chat, video chat, blogs, forums, classifieds, personals, CEs, products, and professional directory listing without accessing multiple websites.

18. The professional social networking web portal as claimed in claim 1, wherein the communications between the one or more professionals are saved in a database for back up, which allows access to such communications in future.

19. The professional social networking web portal as claimed in claim 1, is further configured to obtain emotional and physical response unique to this social network as designed for such groups, the nature and duration of which is corresponsive to the exclusive environment created.

20. The professional social networking web portal as claimed in claim 19, further comprising posting directed advertisement by one or more qualified entities based on the emotional response of a registered member.

21. A method of registering to a professional social networking web portal exclusively targeted to one or more professionals, the method comprising the steps of:
submitting profile information and professional identification information by a member;
verifying the professional identification information of the member by the professional social networking web portal; and
confirming registration of the member based on the authenticity of the professional identification information.

22. The method of registering to a professional networking web portal as claimed in claim 21, wherein the professional identification information comprises at least one selected from legal name, professional license number, country of issuance of the license, area of practice, National Practitioner Identification Number.

23. The method of registering to a professional social networking web portal as claimed in claim 22, wherein verifying the professional identification information further comprises verifying the professional identification information automatically by a third party authentication agency accessed by the professional social networking web portal.

24. The method of registering to a professional social networking web portal as claimed in claim 21, wherein verifying the professional identification information further comprises verifying the professional identification information manually by an administrator of the professional social networking web portal.

25. The method of registering to a professional social networking web portal as claimed in claim 24, comprising registering as an identified member which allows displaying the profile information and professional identification information of the registered member on the professional social networking web portal, wherein the other verified member is authorized to view the profile information and the professional identification information of said verified member.

26. The method of registering to a professional social networking web portal as claimed in claim 25, further comprising registering as an anonymous member wherein the profile information and the professional identification information of said verified member are kept hidden from the other verified members.

27. The method of accessing the professional social networking web portal as claimed in claim 26, further comprising switching one or more times from identified profile to anonymous profile and anonymous profile to identified profile by the verified member who has gone through the login process once, as set forth by the professional social networking web portal.
